(19) United States
(12) Patent Application Publication
(10) Pub. No.: US 2005/0202383 A1
(43) Pub. Date: Sep. 15, 2005

(54) Advance care plan

(76) Inventors: Jill Thomas, Bay Village, OH (US); Glasser Grace, Mentor, OH (US)

Correspondence Address: LINDON & LINDON, 1250 LINDA STREET, ROCKY RIVER, OH, 44116, US

(21) Appl. No.: 11/065,860

(22) Filed: Feb. 25, 2005

Related U.S. Application Data
(60) Provisional application No. 60/547,655, filed on Feb. 26, 2004.

(51) Int. Cl. G09B 23/28

(52) U.S. Cl. 434/262

(57) ABSTRACT

A method of training an interviewer to collect data for use in an advance care plan. The method includes providing a questionnaire directed to lifestyle preferences, and teaching the interviewer how to administer the questionnaire to a person in advance of need for care.

### BACKGROUND OF THE INVENTION

As the American population ages, there is growing need for quality long-term care. The durable power of attorney and living will are widely used legal documents used in long-term care settings. The durable power of attorney and living will help patients document preferred medical decision and decision makers. Unfortunately, these documents do not address a wide variety of important patient preferences, including lifestyle preferences. These lifestyle preferences can contribute significantly to the quality of life of residents and potential users of long-term care facilities and services.

People and their care givers frequently avoid or delay planning for incapacitation or disability. They wait until calamity strikes before addressing and documenting important patient preferences, including lifestyle preferences. There is a long-felt need for an improved means to document lifestyle preferences in advance of need for care incorporating lifestyle preferences.

### SUMMARY OF THE INVENTION

The above advantages as well as other advantages not specifically enumerated are achieved by a method of training an interviewer to collect data for use in an advance care plan. The method includes providing a questionnaire directed to lifestyle preferences, and teaching the interviewer how to administer the questionnaire to a person in advance of need for care. There is also provided a method of gathering data for use in an advance care plan comprising providing a questionnaire directed to lifestyle preferences. There is also provided an advance care plan. The advance care plan includes a display of the lifestyle preferences of a person. The lifestyle preferences of the person are gathered in advance of need for care.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is a flow chart for producing and using an advance care plan in accordance with the present invention.

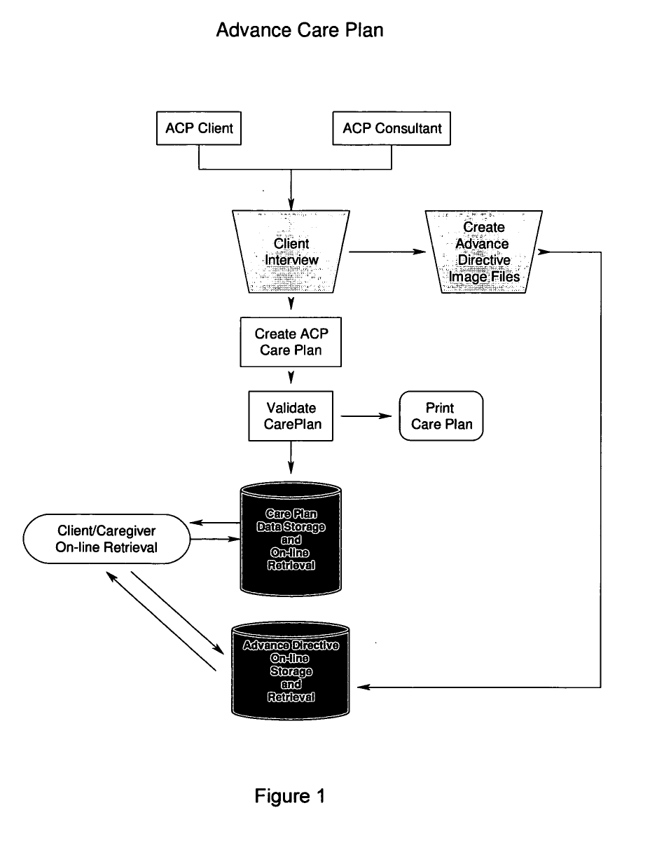

### DETAILED DESCRIPTION OF THE INVENTION

This application claims the benefit of U.S. Provisional Application No. 60/547,655, filed Feb. 26, 2004.

It is important and useful to contemplate and document lifestyle preferences in advance of need for care incorporating lifestyle preferences. A structured data collection process and skilled interviewer training are provided in accordance with this invention. An interviewer training program and a questionnaire substantially similar to the disclosed interviewer training program and questionnaires are provided in accordance with this invention. A goal of the questionnaire and interviewer training program is to produce a patient-specific advance care plan. The term “advance care plan” is understood to include a program or method for documenting and/or delivering medical, social and/or long-term residential services to a specific individual before the individual requires the care of others.

The advance care plan is adapted to provide an individual, or client, with the ability to make lifestyle choices prior to entering a nursing home, assisted living facility, or the like. The advance care plan can be used in home, when in the care of others, a hospital, an assisted living arrangement, a nursing home, or the like. Unfortunately, the desires of the new nursing home resident or assisted living facility resident are typically unknown or simply ignored—particularly regarding lifestyle related matters. As a result, their discomfort and lack of control in their new situation leads to a decline in quality of life. If the individual enters a care facility without the advance care plan, their choices will be limited to what is standard care or even choices of family members who may not know their wishes, reacting only to the current situation. The advance care plan may be stored and retrieved with Living Will and Durable Power of Attorney and Advance Directive.

The advance care plan enables an individual to be proactive in choosing their lifestyle by expressing their choices in several areas. It is desirable to capture lifestyle information from individuals in advance of need for that individual because the information may become “locked up” or otherwise inaccessible in an individual's mind due to dementia, inability to communicate due to a stroke, etc. The advance care plan will display the desires of the individual. To properly administer the advance care plan a training program may be employed. This training program may outline and implement the training required. An objective and outline of each class required to support the ACP may be provided. The qualifications of the instructors may include expertise in the fields of healthcare, computer instruction and business. Course instruction will be designed and delivered to specifically address the needs of the participants.

The advance care plan may elicit and document a given patient's preferences on a wide variety of domains. For example, the advance care plan may document patient's preference for a roommate—whether to have a roommate, the preferred characteristics of that roommate, whether the bed of the roommate or the bed of the patient is located near the window in the room. Of course, simply making these types of preferences known is no guarantee that those preferences will be followed. If such a lifestyle preference is not determined and followed, the patient may be medicated or sedated unnecessarily, with the resultant decrease in quality of life and increase in costs. To further show the advantage of the invention, the following example is offered:

Lynn, at the age of 85, has been placed in the Nursing Home due to a stroke. She is incontinent, but if taken to the bathroom at appropriate times will be continent 95% of the time. She is alert, somewhat confused at times, but very much knows what she wants, though cannot always verbalize it. She is able to feed herself finger foods. Here is a possible description of a day in her life at a rehabilitation center. The story of Lynn compares a patient with an advance care plan and without one.

| Without an Advance Care Plan | With an Advance Care Plan |
|---|---|
| Awakened between 5 and 6 AM. Her hospital | Awakened at 7 AM, taken to the bathroom for |
| gown is taken off; she is given some quick | quick AM care then placed in a comfortable |
| care, dressed for the day in someone else's | chair in her room in front of the TV, with a |
| housedress. (It is a pretty house dress, but | requested show on to wait for breakfast. Stays |
| she does not like house dresses). | in her short PJ's and a robe since it is shower |
| | day. |
| 7:30 AM Taken to the dining room for | 7:30 AM Served breakfast. She is given bacon |
| breakfast. She is given 1 cup of coffee, not | and eggs (her cholesterol is high but she has |
| offered more coffee-not given bacon since her | an advance care plan for a regular diet). She |
| cholesterol is high. | has her 2 cups of coffee, as she has done for |
| | the last 65 years. |
| 8:30 AM After breakfast - she is taken to sit in | 8:30 AM After breakfast she is taken to |
| the hallway outside her room. | bathroom and then to the shower room (this is |
| | the first shower this month so her underarms |
| | and legs are shaved per her care plan.) Her |
| | short hair is washed, as it is with every |
| | shower. (She prefers to shower in the |
| | morning.) After her shower she is dressed in a |
| | navy blue jogging suite with a red tee shirt. |
| | (Per her care plan) |
| About 1-2 hours later she is taken to her room | She has her chap stick around her neck and is |
| to have her brief changed and then sat in the | able to put it on herself frequently. Her lips fell |
| hallway by the nurse's station. (Her lips were | dry, but they do not look dry. Fortunately, it is |
| not moistened, nor does she have any chap | on her advance care plan to moisten lips |
| stick accessible) | frequently and have chap stick available. |
| 10 AM medications - given 6 pills, 2 pills for | 10 AM given 3 pills, 1 for hiatal hernia to |
| high cholesterol, 1 pill for irregular heartbeat, 1 | prevent heartburn, 1 for hypertension and 1 for |
| for hiatal hernia to prevent heartburn, 1 for | arthritis. She no longer takes the pill for |
| hypertension and 1 for arthritis. | irregular heartbeat since it is really not a |
| | problem for her and she has chosen not to |
| | take her cholesterol medication since she had |
| | decided in the past, if she entered a nursing |
| | home, other than for short term, not to take the |
| | majority of her medication. |
| 11 AM She is still sitting in the hall by the | 11 AM She is taken outside to sit in the shade |
| nurses station | (Lynn does not like crafts, she does like to be |
| | outside in the shade). She expressed this in |
| | her advance care plan. |
| 12 N She is taken to the dining room for lunch. | 12 N She is taken back to her room for lunch, |
| She is given lean hamburger, no salt allowed, | placed in her chair in front of the TV. She is |
| and a salad with low fat dressing and | given a cheeseburger, packets of salt, French |
| applesauce. (She needs assistance with the | fries and apple slices. (She has stated in her |
| applesauce) | advance care plan that she does not want to |
| | be fed and would prefer mostly finger foods) |
| 1 PM She is taken to the nurse's station to sit | 1 PM She is taken to the restroom after lunch |
| in the hallway. | and then placed in a recliner to rest and watch |
| | a movie with her DVD player. (The movie is |
| | Pretty Woman, a movie she has seen 50 times |
| | and would like to see 50 more) |
| 2 PM She is placed in bed and has brief | 2 PM She assists the nurses and secretaries |
| changed and is resting. | with shredding paper after her rest. (Has |
| | stated in her advance care plan that she would |
| | like to assist people if there was a way for her |
| | to do that) |
| 3:30 PM She is placed in a wheelchair and | 3:30 PM She gets her weekly manicure. (She |
| taken to ceramics class. | does not like crafts) |
| 5 PM Taken to her room to have brief | 5 PM Taken to the restroom and prepared for |
| changed. | dinner. |
| 5:30 PM Taken to dining room for dinner. She | 5:30 PM Placed in a chair in her room for |
| is served chicken for dinner (loves hot dogs | dinner. She is served hot dogs for dinner with |
| but does not get due to cholesterol) | green peppers slices, mushroom slices and |
| | cherry tomatoes with veggie dip. |
| 6:30 PM After dinner she is taken to the | 6:30 PM After dinner she continues to watches |
| nurse's station to sit in the hall. There is a TV | TV until 7:30. |
| with a DVD at the nurse's station; someone | |
| puts a movie in for those sitting in the hall to | |
| watch. (The movie is Lord of the Rings, one | |
| Lynn has seen several times and does not | |
| really like) | |
| 8:30 PM She is taken to the shower. | Between 7:30 PM and 8 PM she is taken to |
| | the bathroom and gotten ready for bed. |
| | (Placed in her short PJ's) |
| After her shower she is dressed in a hospital | Between 8 PM and 8:30 PM she is placed in |
| gown and put in bed with one pillow at her | bed with a talking book. It is a legal mystery, |
| head. | the type of book she likes. She has stated in |
| | her care plan that she wants to go to bed by 8 |
| | PM and to read. (She is unable to read |
| | independently at this time) |
| The room is 75 degrees and she is very warm | In bed she has down pillows (5 ft.) on either |
| and throws her covers off since she is too | side of her, between her legs, and 3 at her |
| warm to sleep. The staff does come in and | head as outlined in her advance care plan. |
| turn her several times, they place her on her | The room temperature is 70 degrees, which is |
| back (she has never been able to sleep on her | a little hot for her (the temperature cannot be |
| back) they always cover her back up. Her | adjusted due to her roommate). Her personal |
| brief is changed, if needed. | fan is turned on her to keep her cooler. She |
| | sleeps well but is awakened by the staff to |
| | take her to the toilet per her request; this |
| | keeps her continent. |
| The following day, she falls asleep in her chair | The following day she is rested. Her children |
| by the nurse's station since she did not sleep | come and take her to lunch. She is gone |
| well the night before. Her children come to | several hours. When she comes back, she is |
| take her out to lunch but she appears too | placed in her chair for a rest. |
| sleepy so she does not go. | |
| Unfortunately, she is unable to sleep and | She has become adjusted to life in the nursing |
| eventually requests a sleeping pill. When | home. She did not want to become a nursing |
| given this she does indeed sleep, but | home resident, but now realizes she can still |
| becomes totally incontinent at night. She is | have some control and enjoys a high quality of |
| very embarrassed about this and becomes | life. |
| very depressed. The saga continues on a | |
| downward spiral. | |

It will be appreciated that grooming, nutritional, sleeping, social activity, and other preferences can be elicited according to the invention to improve a person's quality of life.

The follow materials may also be employed in accordance with the present invention
ACP QUESTIONNAIRE,
BIOQUESTIONNAIRE,
Glossary of Terms,
Training Plan Overview and Outline,
Executive Summary,
Training Program Schedule, and
Class Outlines.

Brochures with the following text, or a suitable substitute, may also be employed in accordance with the present invention:

### HAVE YOU PLANNED FOR YOUR PERSONAL LIFESTYLE DESIRES?

Many seniors have planned carefully for end-of-life decisions by preparing a Living Will and appointing a Durable Power of Attorney for health care decisions. But virtually none have prepared a document which will convey their wishes with regard to day-to-day personal lifestyle desires should they become a resident in a nursing home.

The Advance Care Plan is just such a document. Prepared by a healthcare professional and based upon your individual values, preferences and routines, this document becomes your official input into the federally and state mandated Plan of Care which will be created by the Nursing Home staff.

### ADVANCE CARE PLAN

Your ACP, Inc. Consultant, an experienced healthcare provider, will interview you in the privacy of your own home, where they will create an Advance Care Plan for you incorporating realistic approaches for maintaining your quality of life during a nursing home stay. This document is then electronically stored and updated periodically based upon changes in your health, circumstances and preferences. Should you become a nursing home resident for any period of time, you can choose to have your ACP, Inc. consultant visit your nursing home and train the staff on the requirements of care set forth in your Advance Care Plan.

Your ACP, Inc. Consultant can also offer you a variety of other professional services designed to ensure your well being, and tailored to your individual needs and preferences. We will help you prepare for the optimal, productive and comfortable nursing home stay possible, and will advocate for your choices.

### BE PREPARED

Without an Advance Care Plan, the care and services you receive will be driven by the policies, procedures and routines of the facility, not by the habits, preferences and values you have developed over a lifetime. With an Advance Care Plan in place, the nursing home staff will be required to integrate your specific directives into their day-to-day interventions, thereby creating a truly individualized Plan of Care to promote your ongoing health, well-being and emotional comfort. A minimal investment of time and resources could help you to avoid loss of your well-being and sense of independence and autonomy. You may already have directives in place explaining to others how you wish to let go of life. Make sure they also know how you wish to live it.”

Ensuring that your personal lifestyle desires are known and respected by caregivers in a healthcare setting.

Your life.

Your identity is defined by much more than your vital statistics. Your disposition, your values, your needs, your likes and dislikes, even your routine reflect the person you are and the life you choose to live. You determine who YOU are. As you age, illness or infirmity may make it difficult for you to express yourself and to maintain an independent lifestyle that expresses your individuality. Disease may be the culprit—the number of Americans with Alzheimer's disease has more than doubled since 1980. Stroke or other impairment can strike without warning, causing you to rely on others for your care and robbing you of the ability to communicate what's important to you. These life-changing events can result in loss of your identity, leaving you totally dependent on people who may know who you are, but who do not really know you. While well-intentioned healthcare providers exercise the golden rule—treating you as they'd like to be treated themselves—wouldn't it be better if they treated you the way YOU want to be treated?

Your desires.

Using a revolutionary new software system, the Advance Care Plan helps you invest in the future. Financial advisors will tell you that today, when nine out of 10 people live to age 65 and beyond, retirement planning is not only realistic, it's necessary. But while finances are important, money is not the only important capital. Why not bank your thoughts?

The Advance Care Plan is a knowledge-management system developed for people aged 50 and older. It identifies your specific habits, preferences, needs and desires for life lived in the care of others. Experts tell us that 70 percent of people 65 and older will require some type of long-term care in their lifetime. It's never too early to start planning for the possibility.

Many seniors plan for the end of their life by preparing a Living Will and appointing a Durable Power of Attorney for healthcare decisions. But virtually none have prepared a document that conveys their wishes with regard to day-to-day quality of life issues. The Advance Care Plan is just such a document.

The Advance Care Plan is patent pending, developed by Advanced Care Planning, Inc., a company that believes that all people—regardless of age or health status—should enjoy control, dignity, self-respect, freedom of choice and quality of life.

Your care.

Until now, there was no mechanism available to gather, organize, document and disseminate your personal needs, desires, habits and preferences to caregivers. The Advance Care Plan is stored online in a secure HIPAA-compliant system that houses your biography and needs-based care plan and is confidentially referenced through specialized software.

“. . .I find this to be innovative and revolutionary. . .This plan would take these small details into account and improve patient care, quality of life and overall sense of well being”—Michael Mazowiecki, M.D., Neurologist, Co-director of North Colorado Memory Loss Center

“. . .It is a cutting-edge tool in which the client's needs and desires are uniquely articulated. . .a powerful win-win situation.”—Gloria Blackmon, R.N.

“Advance Care Planning fills the gap left by advance directives. . .it will be a powerful tool for any advocate or decision maker attempting to carry out another's wishes.”—Terry Ann Donner, R.N., J.D., Aging Matters LLC

“A wonderful and needed product to capture a person's life story and enhance the quality of care. . .”—David Troxel, co-author, The Best Friends' Approach to Alzheimer's Care

To learn more about the benefits of an Advance Care Plan, call (877) 227-7235 or visit www.advancecareplan.com.

Your needs.

The Advance Care Plan was developed by experienced healthcare professionals who understand that people in their care are often overwhelmed and can be shy about stating their wishes. In times of stress, family members make decisions on behalf of their loved ones, but those decisions may not reflect the person's true desires. Even if you're no longer able, the Advance Care Plan allows you to speak for yourself.

A trained consultant gathers information to develop a document that spells out exactly how you wish to live life in the care of others and even how you wish to let go of life.

The information-gathering process itself allows you to catalog your life's experiences and accomplishments—a great gift to your loved ones. At the same time, you are able to identify your preferences for daily life, crucial because one in two people will spend time in a nursing home and 75 percent of people 65 and older will need some type of home health care during their lifetime.

The Advance Care Plan contains information pertinent to all types of care, whether you're treated by healthcare providers at home, in an assisted-living facility, nursing or rehabilitation center.

A suitable advance care plan questionnaire may be administered to a client and/or prospective client in any suitable manner. An example of a suitable advance care plan questionnaire is shown.

[image]

[image]

[image]

[image]

[image]

[image]

[image]

[image]

[image]

[image]

[image]

[image]

[image]

[image]

[image]

[image]

[image]

[image]

[image]

[image]

[image]

When the questionnaires are administered to a client, an advance care plan may be compiled and/or produced for a client. The questionnaires, and any appropriate worksheets as desired, may be administered in any suitable manner to collect data for the advance care plan.

### ACP Care Plan Prepared for (Insert Name Here)

1. To feel comfortable in a suitable environment.
Need: To feel comfortable in a suitable environment.
Goal:_will maintain his/her normal patterns of living, as evidenced by
verbal/non-verbal expression of satisfaction.

| | |
|---|---|
| Interventions/Pertinent Information | Discipline |

1) Institutional Care:
2) Home or institution:
2. Activities of Daily Living - Dressing/Grooming/Bathing
Need: To be appropriately dressed and groomed.
Goal:_will be clean and appropriately dressed and groomed each day.
_will be as independent as possible in his/her activities
of daily living.

| | |
|---|---|
| Interventions/Pertinent Information | Discipline |

3. Activities of Daily Living - Mobility/Safety
Need: To be Mobile and safe.
Goal:_will remain safe in present environment.

| | |
|---|---|
| Interventions/Pertinent Information | Discipline |

4. Activities of Daily Living - Bowel and Bladder function.
Need: Normal Bowel and Bladder function
Goal:_will maintain pre-admission bowel and bladder habits
and maintain/attain continence.

| | |
|---|---|
| interventions/Pertinent Information | Discipline |

5. Activities of Daily Living - Nutrition
Need: To Receive proper Nutrition
Goal:_will be healthy, and maintain a suitable body weight.

| | |
|---|---|
| Interventions/Pertinent Information | Discipline |

6. SocializationlActivities
Need: Proper socialization and activities.
Goal:_will verbalize/show non-verbal signs of enjoyment
in the activities planned for him/her.

| | |
|---|---|
| Interventions/Pertinent Information | Discipline |

7. Communication
Need: To see, hear and communicate with others as well as possible.
Goal:_will see as well as possible, and will communicate
effectively using verbal and nonverbal means.

| | |
|---|---|
| Interventions/Pertinent Information | Discipline |

8. Health Maintenance - Comfort
Need: To maintain the best possible health.
Goal:_will maintain the best possible health, and live in comfort.

| | |
|---|---|
| Interventions/Pertinent Information | Discipline |

9. Emotional/Spiritual
Need: To maintain emotional/spiritual well being
Goal:_will verbalize/show non-verbal expressions of
emotional well-being.

| | |
|---|---|
| Interventions/Pertinent Information | Discipline |

10. End of Life Care
Need: To live the end of life with comfort and dignity.
Goal:_will be pain/symptom free.

| | |
|---|---|
| Interventions/Pertinent Information | Discipline |

A pet-related questionnaire, or worksheet, may also be employed to prepare the advance care plan.

### Pet Work Sheet

If there is anything of particular importance about your pet(s) that you wish to document in the pet form. This information will be included on the information sheet. Please consider the following questions.
1. What type and number of animals do you have?
2. What are their names?
3. What do you call them?
4. Do they have any pedigree's or special heritage you wish known?
5. What is their usual diet? (Please include times and brand names and treats if applicable)
6. What is their normal routine?
7. What are their toileting habits?
8. Where do they sleep? (include type of bed, if applicable)
9. Do they have any special toys?
10. Are their any tricks they know or have any special habits? (Please include bad habits, you think a caregiver should know about)
11. Who do you wish to care for your pets, if you were unable to? Have you made any provisions?
12. Current Veterinarian?
13. Is there any thing else you would like to document about your pets?

An example of a completed advance care plan for a hypothetical patient “Betty Blue” is shown below. Data which pertains to Betty Blue has been inserted for purposes of illustration of a more finished advance care plan. The advance care plan can be compiled, displayed, used, and accessed in any suitable manner. For example, a network, internet means, or the like may be employed.

### Advance Care Plan Prepared for Betty Blue

1. To feel comfortable in a suitable environment.
Need: To feel comfortable in a suitable environment.
Goal: Betty will maintain his/her normal patterns of living, as evidenced by
verbal/non-verbal expression of satisfaction.

| Interventions/Pertinent Information | Discipline |
|---|---|
| 1) Institutional Care: | |
| Betty prefers to be addressed as Betty. | All |
| Betty states that in the event of mental or physical impairment, and if a | AD/SS |
| physician recommends that she go into a nursing home or assisted care facility, | |
| she will take the advice with some reservation. | |
| Comments: I may not want to go to a facility, but I realize I may have to. | |
| If Betty were to become institutionalized, she would prefer a private room. | AD/SS/N |
| Betty prefers that the door to her room remain open, and the curtain open. | AD/SS/N |
| Comments: I would like as much activity around as possible. | |
| Betty prefers a bed away from the door. | AD/SS/N |
| Betty has problems with certain personality types in others. | AD/SS/N |
| 2) Home or institution: | |
| Furniture: Family Pictures | AD/SS/N |
| Bedding: A light weight down comforter and pillows. | |
| Dolls or Stuffed Animals: I would like some of my dolls from my collection, | |
| especially a baby doll. | |
| Betty would like Bob Blue involved n her life in an extended care facility. The | AD/SS/N |
| relationship is that of Husband. The occupation is House Husband. | |
| Comments: Wonderful Dad. | |
| Betty would like to maintain her normal daily routine, described as follows: | AD/SS/N |
| Weekdays: I get up at 7 am and drink coffee and hot chocolate, read the paper, | |
| then shower, dress and go to my appointments. Weekends: I sleep until 10 am | |
| on Saturday and then drink my coffee and hot chocolate, read the paper and | |
| then do my errands and house work. On Sunday I spend the day in church. | |
| Betty does not smoke. Comments: I do not like to be around smoke. | SS/N |
| Betty does not drink alcohol. | SS/N |
| Betty gets up at 7 AM and desires to maintain the same schedule in the later | SS/N |
| years. She goes to bed at 10 PM and desires to maintain the same schedule in | |
| the later years. | |
| Betty does not take a nap during the day. | SS/N |
| Betty wears long pajamas to bed at night. She would like to maintain the same | |
| routine in a facility. Comments: I wear long pajamas most of the time, | |
| flannel in the winter and cotton in the summer. | |
| On a scale of 1 = soft to 100 = hard, Betty selected 50 for a mattress, and may | AD/SS/N |
| need an advocate to supple the mattress. | |
| Betty does not use a night light. | SS/N |
| Comments: I do want a glass of wate at my bedside. | |
| Betty uses 2 down pillows. Comments: Pillows at my head only. | AD/SS/N |
| Betty sleeps with covers even it the room is warm. | SS/N |
| The following describes the manner in which Betty sleeps: | SS/N |
| Comments: I sleep in any position and turn frequently. | |
| Betty sleep most comfortably is the room temperature is set at 70. | SS/N |
| Betty has trouble falling asleep. She takes no medication to aid sleep, but does | SS/N |
| drink warm milk at bedtime. | |

2. Activities of Daily Living - Dressing/Grooming/Bathing
Need: To be appropriately dressed and groomed.
Goal: Betty will be clean and appropriately dressed and groomed each day.
Betty will be as independent as possible in his/her activities of daily living.

| Interventions/Pertinent Information | Discipline |
|---|---|
| If cognitive impairment is present, and Betty refuses a bath, shower or other | N/SS |
| routine grooming, she states that she desires to be compelled. | |
| Comments: I want to go kicking and screaming. | |
| Betty states that she would feel a little uncomfortable with a staff member of the | N/SS |
| sex bathing her or cleaning her person. | |
| Comments: If it wa a professional care giver it would be OK. | |
| Betty would prefer to receive assistance in activities of daily living from a | AD/SS |
| healthcare professional. Comments: I do not want to burden my family. | |
| Betty takes 7 showers a week. | AD/SS/N |
| Betty has requested the following services: | AD/SS/N |
| A haircut, Once a month | |
| A massage, Once a month | |
| Betty washes her hair 7 times a week. | N |
| Betty has normal skin. | N |
| Comments: I want eucercin lotion to my hands and feet twice a day. | |
| Betty does not wear perfume. Comments: It makes people sick. | N |
| Betty believes that, with respect to dress, fashion is not more important that | N |
| comfort/function. Comments: I value comfort. | |
| Betty has indicated that she avoids wearing certain colors and patterns. | N |
| These are: plaids. | |
| Betty would be willing to wear to wear adaptive clothing such as Velcro in place | N |
| of zippers, buttons, or snaps if she had difficulty dressing. | |
| Betty prefers to wear pants with an elastic waist. | N |
| Betty wears a bra daily. Bra type: sports bra. | N |
| Betty brushes her teeth 2 times a day. | N/SS |
| Comments regarding dental hygiene: I like whitening toothpaste. | |
| Betty brushes her teeth 1 time a day. | N/SS |
| Betty does not wear false teeth or other dental appliances. | N/SS |
| Betty uses a Sona care toothbrush. | N/SS |
| Betty does not have dental problems. | N/SS |

3. Activities of Daily Living - Mobility/Safety
Need: To be Mobile and safe.
Goal: Betty will remain safe in present environment.

| Interventions/Pertinent Information | Discipline |
|---|---|
| If cognitive impairment is present and Betty refuses a prescribed restraint/ | N/PT/SS |
| restrictive device, she would want the DPOA consulted. Comments: I would | |
| not want to be disruptive, but I do want freedom of movement. | |
| If Betty becomes restricted in her ability to move, she desires the following | N/PT/SS |
| interventions: | |
| Physical therapy and/or a restorative nursing program. | |
| A chair from which she couldn't rise unattended, for instance, and Adirondack | |
| chair. | |
| A Vail bed. Comments: I think it would make me feel secure. | |
| Railings on the walls and furniture. Comments: It would help me be steady. | |
| Independence is of great importance to Betty. | N/PT/SS |
| Comments: I would like to stay as independent as possible. | |

4. Activities of Daily Living - Bowel and Bladder function.
Need: Normal Bowel and Bladder function
Goal: Betty will maintain pre-admission bowel and bladder habits and maintain/attain
continence.

| Interventions/Pertinent Information | Discipline |
|---|---|
| The normal voiding habits of Betty are as follows: | N |
| Comments: I void frequently in the morning, due to the water pill I take and | |
| the coffee I drink, after that about every 4 hours. | |
| The normal bowel habits of Betty are as follows: | N/D |
| Once a day in the morning. | |
| Betty has a history neither of constipation nor of irritable bowel syndrome. | N/D |
| In a situation where Betty becomes incontinent, she would prefer the following | N/PT |
| measures be undertaken: | |
| Comments: I expect to be awakened in the night to go to the bathroom. | |
| In a situation where Betty becomes incontinent, she would prefer the following | N/PT |
| measure not be undertaken: | |
| Comments: None, I want everything done. | |

5. Activities of Daily Living - Nutrition
Need: To Receive proper Nutrition
Goal: Betty will be healthy, and maintain a suitable body weight.

| Interventions/Pertinent Information | Discipline |
|---|---|
| On Feb. 16, 2005, Betty reported her weight to be 135 lbs. She would not be | N/D |
| willing to diet in order to optimize her weight. | |
| Comments: I want to maintain my normal eating patterns. | |
| If Betty became cognitively impaired and refused a therapeutic diet. It would be | N/D/SS |
| her wish to be allowed to refuse. | |
| Comments: If I am cognitively impaired or very ill, I would want to eat what I | |
| wanted. | |
| Betty would prefer to take her meals in her room, all three meals the same. | N/D |
| Betty is on a high fiber diet. | D |
| Betty generally eats the following: I eat protein bars for breakfast and lunch and | D |
| a balanced meal in the evening. | |
| Betty drinks hot chocolate. Comments: I like to drink this year round. | D |
| Betty has indicated the following beverage preference: | D |
| Drink: Water Comments: I drink 3 quarts of water a day. | |
| Drink: Caffeine free diet coke. | |
| Betty has listed the following as her favorite foods: | D |
| Food Item: Pizza Comments: I like pepperoni on my pizza. | |
| Food Item: Hamburgers with cheese. | |
| Betty has listed the following as distasteful food: | D |
| Food Item: beets | |
| Betty is intolerant of or allergic to the following: | D |
| Food item: Spinach Comments: Upsets my GI tract. | |
| Betty has indicated that she would not be willing to use adaptive utensils as | D |
| aids to self - feeding. | |

6. Socialization/Activities
Need: Proper socialization and activities.
Goal: Betty will verbalize/show non-verbal signs of enjoyment
in the activities planned for her.

| Interventions/Pertinent Information | Discipline |
|---|---|
| Encourage visitation and participation in activity planning by Bob Blue. | SS/A |
| In planning activities for Betty, consideration should be given to the following | SS/A |
| information regarding her career history: housewife and mother. | |
| Betty celebrates the following: (factors that should be considered in preparation | A |
| of her social activities.) | |
| Tradition: Christmas Eve. Comments: Goes to church. | |
| Tradition: Christmas. Comments: wake up early with children. Have | |
| turkey dinner and sing Christmas carols. | |
| Betty has belonged to the following organizations(s), factors that should be | A |
| considered in the preparation of her social activities. | |
| Organization: Housewives of America | |
| Organization: PTA Comments: I was president in 2001. | |
| Betty has expressed the following preferences: | A |
| Favorite Color: Red | |
| Favorite Place: Home | |
| Favorite Flower: Rose | |
| Favorite Literary Works: Red book | |
| Favorite Film: I do not like movies | |
| Favorite Music: Classical | |
| Favorite Animal: Dog | |
| Betty would prefer to have her activities planned by staff. | A |
| Comments: I want to part of a group. | |
| Socially, Betty prefers small groups all of the time. | A |
| Comments: I get overwhelmed in groups of more that 8 people | |
| Betty would like visitation from her family. | A |
| Comments: I value my family and want to visit often. | |
| Betty enjoys the company of children. On a scale of one (very much dislikes | A |
| children (to one hundred (likes children very much) Betty has selected the | |
| number 47 to represent her feelings about children. | |
| Betty enjoys watching the following on TV: Game shows. | A |
| Betty does not enjoy reading. | A |
| Betty would like to celebrate occasions by wearing birthday hats, crowns, beads | A |
| and other related items. | |
| Betty does not enjoy gardening. | A |
| Comments: I do not like to get dirt under my nails. | |
| Betty enjoys crafts. | A |
| Comments: I love to make pot holders. | |
| Betty enjoys crossword puzzles. | A |
| Comments: I like to do cross word puzzle books. | |
| Betty enjoys the out of doors. | A |
| Comments: I like to be in the sun. | |
| Betty has developed the following skills over her lifetime: I keep a very clean | A |
| house. | |
| Betty has listed this from among activities, show, places, music, etc. that she | A |
| has experienced over her lifetime, giving her the most pleasure, or evoking the | |
| best memories: Classic rock. | |

7. Communication
Need: To see, hear and communicate with others as well as possible.
Goal: Betty will see as well as possible, and will communicate effectively using verbal and
non verbal means.

| Interventions/Pertinent Information | Discipline |
|---|---|
| Betty wears glasses. Comments: for reading | All |
| If cognitive impairment were present and Betty had a vision problem, she states | N/SS |
| that she would desire to receive all available remedies, including surgery. | |
| Comments: It is important to be able to see. | |
| If cognitive were present and Betty had a hearing problem, she states that she | N/SS |
| would desire to have a hearing aid. | |
| Comments: It is important to be able to hear. | |
| If cognitive impairment were present and Betty had a speech problem, she | N/SS |
| states that she would desire to have a communication board. | |
| Comments: I want to be able to make my needs know. | |
| Betty has indicated that her primary language and mode of communication is: | N/SS/ST |
| English. | |
| Betty feels that she has no problem communicating with others. | N/SS/ST |
| Betty is right handed. | N/SS/ST |

8. Health Maintenance - Comfort
Need: To maintain the best possible health.
Goal: Betty will maintain the best possible health, and live in comfort.

| Interventions/Pertinent Information | Discipline |
|---|---|
| Betty suffers from chronic pain. | N/PT |
| Comments: I have arthritis and use a heated balm on my joints at bedtime. | |
| Betty indicates that she holds not religious or moral objections to any medical | N/SS |
| procedures. | |
| Comments: I trust Jim Jones (physician) will do the right thing. | |
| Betty believes that cost should not be considered in the delivery of healthcare. | N/SS |
| If cognitive impairment is present and Betty refuses a prescribed medication, | N/SS |
| she wants to have the DPOA consulted. | |
| Comments: I just want to be comfortable. | |
| If cognitive impairment is present and Betty refuses to allow the staff to position | N/SS |
| her so, as to prevent adverse conditions such a pressure ulcers, she want the | |
| DPOA consulted. | |
| Comments: I want the decision to be made by others. | |
| Betty has indicated that she expects to have different views on healthcare | N/SS |
| issues in later life. | |
| Comments: I think I may, but I am not sure what they may be, at this time. | |
| Betty indicated that she holds moral or ethical positions that might affect her | N/SS |
| decisions about healthcare in the event of her cognitive impairment. | |
| Comments: I do not want to spend my last years in an institution of any type. | |

9. Emotional/Spiritual
Need: To maintain emotional/spiritual well being.
Goal: Betty will verbalize/show non-verbal expressions of emotional well-being.

| Interventions/Pertinent Information | Discipline |
|---|---|
| If cognitive impairment were present and doctor recommended institutional care | All |
| for Betty, she would want to take his advice with some reservations. | |
| Comments: I may not want to go to a facility, but I realize I may have to. | |
| If Betty were cognitively impaired, and a doctor recommended that she be | All |
| institutionalized, she would prefer to consult further with: | |
| A family member, Husband and children. | |
| Her clergyman. | |
| Betty has expressed the following with respect to what she desires to | N/SS |
| accomplish in the remaining years of her life: “Travel to New York” | |
| Betty has rated a number of value-related questions, using a scale of from one | N/SS |
| (values very little) to five (values very much). The results are as follows: | |
| Feeling useful and necessary: 4 | |
| Feeling values: 4 | |
| Living a long life: 3 | |
| Living an active life: 5 | |
| Being able to life independently: 4 | |
| Being able to live in her own home: 4 | |
| Enjoying the company of family and friends: 5 | |
| Being able to recognize significant others: 5 | |
| Being able to communicate effectively with others: 5 | |
| Being able to think clearly: 4 | |
| Being able to perform her own activities of daily living: 3 | |
| Being free from disease symptoms or debilitating conditions: 4 | |
| Betty has rated on a scale from one to one hundred, her valuation of length | All |
| versus quality of life. A lower value tends toward quality of life; a higher value | |
| toward length of life. Her choice is 34. | |
| If a drug were suggested that would help Betty to cooperate and have a greater | All |
| sense of well-being, she would want to take it. If the medication had a potential | |
| for serious side effects, she would be inclined toward taking it. | |
| Comments: I always want to cooperate. | |
| If Betty should become cognitively impaired and child-like, it would be her wish | All |
| to be humored. | |
| Comments: I like stuffed animals and dolls now. I am sure I always will. | |
| Betty has a religious faith. | All |
| Comments: I go to a Unitarian church. | |
| Betty would like visitation by a clergyman. | All |
| Comments: My current clergy. | |
| Betty has expressed concerns about spiritual matters that she would like to | All |
| bring to the attention of caregivers. Please review dietary restrictions with | |
| regard to Betty's religious faith. | |
| Comments: I pray before I go to bed. | |
| Betty has indicated her disposition on a scale of one (very calm) to one hundred | All |
| (very animated). The value she has selected in 48. | |
| Comments: I think I am an average person. | |
| Betty has indicated her energy level on a scale of one (very low) to one | All |
| hundred (very high). The value she has selected is 54. | |
| Betty has rated her personal flexibility level on a scale of one (flexible) to one | All |
| hundred (inflexible). The value she has selected in 73. | |
| Betty has indicated that she does not have phobias. | All |
| Betty has indicated that, in the event of an emotional upset, she regains | All |
| composure according to the following: Watch game show. | |
| Betty defines the term “quality of life” as follows: To be able to enjoy family and | All |
| be comfortable. | |

10. End of Life Care
Need: To live the end of life with comfort and dignity.
Goal: Betty will be pain/symptom free.

| Interventions/Pertinent Information | Discipline |
|---|---|
| If Betty were terminally ill, she would want to be hospitalized for therapeutic | SS/N |
| treatment under no circumstances. | |
| Comments: Unless it was for comfort. | |
| In the event Betty were terminally ill and required an extraordinary procedure | SS/N |
| such as a tracheostomy, or chemotherapy, she would not want the procedure | |
| unless it enhanced her quality of life. | |
| Comments: I wan to end life with dignity. | |
| In the event Betty were in a severely compromised state of health, she would | SS/N |
| not want to have measure undertaken to prolong her life. | |
| Comments: I want of die with dignity and comfort. | |
| Betty would prefer not to be fed in the event she became cognitively impaired, | SS/N |
| and could not feed herself. | |
| In the event of severe weight loss, or an inability to swallow safely, Betty would | SS/N |
| not want a feeding tube, even if it meant death by starvation. | |
| Comments: It would be time for me to go, unless I was under 65 and the | |
| tube was to strengthen only and then it would be removed. | |
| Betty has requested that she not be resuscitated if she had the following: | SS/N |
| Alzheimer's or another severe dementia. | |
| Terminal illness such as cancer. | |
| Advanced stages of a chronic progressive debilitating disease such as MS or | |
| Parkinson's disease. | |
| Comments: If I was at a terminal stage, I wound not want to be resuscitated, | |
| no matter what the cause. | |
| If Betty were to have cognitive impairment, she would not want to be | SS/N |
| resuscitated, if she had the following: | |
| An inability to walk. | |
| An inability to feed herself. | |
| An inability to swallow food or fluids. | |
| An inability to talk. | |
| An inability to comprehend words or instructions, or to carry on a meaningful | |
| conversation. | |
| Betty has experience the death of a close loved one. | SS/N |
| Comments: But by natural causes. | |
| Betty has expressed apprehension about the prospect of death. | SS/N |
| In the event of her demise, Betty has indicated that she would desire to speak | SS/N |
| to her daughter. | |
| Betty would not prefer to die at home, even if comfort could be maintained in | SS/N |
| the event of a short-term, terminal illness. | |
| Comments: It might be upsetting for my family. | |
| Betty has made no funeral plans. | AD/SS/N |
| Betty wishes to be buried. | AD/SS/N |
| Betty has not discussed the prospect of death with anyone. | AD/SS/N |
| Comments: Not yet. | |
| Betty indicates that she has not witnessed a particularly difficult death of a | AD/SS/N |
| family member or someone close. | |

Biographical/General Information for Betty Blue
Confidential Information

General Information:
Name: Betty Blue Nickname: Bee
Prefers to be addressed as Betty.
Current Address:
333 Happy Street
Happyville, CA 67890
Telephone: 123-456-7890 Email: bee@aol.com
Birth date: Aug. 16, 1956 Birthplace: Happyville, CA Citizenship: USA
Marital Status: Betty is married. Name. Bob Blue Occupation: House Husband
Betty would like to have Bob Blue included in her life during her stay in a facility.
Bob Blue's relationship: Husband. Occupation: House Husband
Father's Name: Tom Smith Occupation: Carpenter
Mother's Name: June Smith Occupation: Housewife
Betty had this to say about her parents: Married for 50 years and had 2 children.
Loving couple and parents.
Betty has the following sibling:
Sibling: Sue Song Age: 45 Sister Occupation: Dental Assistant
Telephone: 123-456-6789 Email: sue@aol.com
Comments: Married with 2 children.
Betty has the following child:
Betty Age 10 daughter
Betty has the following friend:
Susie Q Age 50 Sex: female Occupation: Secretary
Betty has attended the following school: Happyville High
Comments: I did not go to college and all of my schools were in Happyville.
Betty has worked at the following employers:
Happyville Hardware Comments: My first job, the only girl there.
McDonalds From: 1998 Until: Present
Comments: I work there now and it is only the second job in my lifetime.
Betty has this to say about significant careers in her life: House wife and mother.
Betty has lived at the following residences:
Street: 55 Elm Street
State: Happyville, CA 67890
Street: 333 Happy Street
State: Happyville, CA 67890
Betty has traveled to the following location:
Travel location: San Francisco Time frame: 2000 Duration: 2 days
Comments: This is the only place I have been outside Happyville.
Betty has belonged to the following organizations(s), factors that should be
Considered in the preparation of her social activities.
Organization: Housewives of America
Organization: PTA Comments: I was president in 2001.
Betty observes the following traditions:
Tradition: Christmas Eve. Comments: Goes to church.
Tradition: Christmas. Comments: wake up early with children. Have
turkey dinner and sing Christmas carols.
Betty recalls the following as her fondest memory: Getting married and giving
birth.
Betty recalls the following as a turning point in her life: My life is the way I want it
with no significant events.
Betty feels that the following information regarding her background would be of
importance to caregivers: I was the queen of the hop my senior year of high
school.
Betty feels that the following is of great personal importance: My Family.
Betty would still like to accomplish the following life goal: Travel to New York.
Betty has the following favorites:
Favorite Color: Red
Favorite Place: Home
Favorite Flower: Rose
Favorite Literary Works: Red book
Favorite Film: I do not like movies
Favorite Music: Classical
Favorite Animal: Dog

The following is a list of the categories for that may be used with the advance care plans. Each advance care plan preferably has a need, goal, interventions to meet that goal and the discipline(s) preferably responsible to carry out or see that those interventions are complied with. One suitable code for the disciplines which may be used is as follows: A=Activities, AD=Advocate, All=All disciplines, D=Dietary, N=Nursing, OT=Occupational Therapy, PT=Physical Therapy, ST=Speech Therapy, SS=Social Services.

The advance care plan may include any suitable number of areas which might be useful to address in data collection, use, assembly, or presentation of the advance care plan. The following are offered as possible examples:
1. To feel comfortable in a suitable environment.
2. Activities of Daily Living—Dressing/Grooming/Bathing
3. Activities of Daily Living—Mobility/Safety
4. Activities of Daily Living—Bowel and Bladder function.
5. Activities of Daily Living—Nutrition
6. Socialization/Activities
7. Communication
8. Health Maintenance—Comfort
9. Emotional/Spiritual
10. End of Life Care

The advance care plan can be administered and data for the advance care plan collected by any suitable means. Non-limiting examples of suitable means include electronic, manual, in-person, remote, interview, paper-based, exercises, role-play, and computer-based means.

Persons who have been properly trained and oriented according to the invention may administer the advance care plan and collect, collate, display and/or present an advance care plan and associated data. Training may be administered by any suitable element(s). For example, training may be administered by, lecture, paper-based, exercises, role-play, handouts, or computer-based means.

The advance care plan can be administered and data displayed by any suitable means. Non-limiting examples of suitable means include electronic, manual, in-person, remote, interview, paper-based, exercises, role-play, and computer-based means.

A worksheet, questionnaire or the like may be employed to gather data for the advance care plan. An adaptable example of a worksheet is shown herein:

### IADL Work Sheet

Please consider the following questions. If there is anything of particular importance to you, please indicate in the final information form.

1. If you do not have a durable power of attorney for finance and you needed someone else to assist with financial management (e.g., writing checks, paying bills, doing banking), who would you want that person to be.
Keep in mind you may need assistance due to cognitive impairment, mobility issues, decreased visual acuity, illness or hospitalization.

2. Are there specific routines you wish to have adhered to with regard to the following:
Laundry
Dishwashing
Furniture cleaning
Appliance cleaning
Floors/carpets
Bathroom cleaning
Windows
Linen/bed changing

3. Are there any specific products you wish to have utilized?

4. Are there any specific products you do not want utilized?

5. Are there any other household do's or don't?

Training in data collection and administration of the advance care plan may be employed in any suitable manner. An example of a course outline which may be employed is shown as follows:

Course Outline

| Day | Chapter/Subject | Time |
|---|---|---|
| Day One | Continental Breakfast 8:00 AM | 8:30 AM |
| | Chapter Eight - Introduction to Basic | 4 Hours |
| | Care Planning | |
| | Lunch | 1 Hour |
| | Chapter One - Company Profile | 4 Hours |
| | Chapter Two - Corporate Expectations | |
| Day Two | Continental Breakfast 8:00 AM | 8:30 AM |
| | Load and configure software | 1 Hour |
| | Chapter Three - The Advance Care Plan | 4 Hours |
| | Lunch - In room | 30 Minutes |
| | Pictures for ACP Identification Badges | 30 Minutes |
| | Chapter Four - Client Interview Skills | 2 Hours |
| | Class ends - group dinner | 5:30 PM |
| Day Three | Continental Breakfast 8:00 AM | 8:30 AM |
| | Role Play from Client Interview Skills | 1 Hour |
| | Chapter Five - Marketing for Licensees | 2 Hours |
| | Lunch - In room | 30 minutes |
| | Chapter Six - Selling for Licensees | 2 Hours |
| | Role Play from Selling for Licensees | 30 minutes |
| | Chapter Seven - Wrap-up | 1 Hour |
| | End class | 3:30 |

The following supplies, or suitable substitutes and/or compliments may be employed:
Room sufficient in size for number of students
Laptop with presentations and ability to access care plan
LCD projector
Screen for projection or suitable wall
Flip chart with markers—optional
Class material in binders
Class handouts on CD
Breakfast for 3 days
Lunch for 2 days—optional
Snacks for 2 days
Candy
Name tags/name tents

### Course Outline

Course Objective:

The purpose of the Advance Care Planning, Inc. class is to train the licensee in all the areas needed to market, sell and deliver the Advance Care Plan for their client. The training class is 3 days. In addition to the class, the licensee is provided with a number of checklist, guidelines and templates to enable them to start their Advance Care Plan business.

Upon completion of the class, the licensee will be able to market, sell and service their client to deliver an Advance Care Plan.

Class Content: The Advance Care Planning, Inc. class consists of the following:
Introduction to Basic Care Planning
Company Profile
Corporate Expectations
The Advance Care Plan
Client Interview Skills
Marketing for Licensees
Selling for Licensees
Wrap-up

Each section objective and section content is outlined below.

### Introduction to Basic Care Planning

Section Objective:

This section is offered at the beginning of the training session. The purpose of this section is to familiarize the student with basic care planning knowledge and skills. This section is for licensees who have little formal care planning experience.

Upon completion of this section, the licensee will be able to verbalize an understanding of care planning.

Section Content: This section is a half day and covers the components of a traditional care plan. The definition of a care plan, the purpose of the care plan and the basic components of a traditional care plan are covered. Examples of a traditional care plan are presented. The regulations regarding care planning are discussed. The care planning process is presented with each component discussed in detail. Development and types of care plans are detailed.

### Company Profile

Section Objective:

The purpose of this section is to familiarize the licensee with the founders of Advance Care Planning, Inc and the standards of practice of the company.

Upon completion of the class, the licensee will be able to verbalize the company history and standards of practice.

Section Content: This section outlines the history and founders of Advance Care Planning, Inc. The vision and mission of the company is presented. The standards of practice and values of the company are discussed. Ruth's story is presented as an introduction to the benefits of the Advance Care Plan. Corporate support information is provided.

### Corporate Expectations

Section Objective:

The purpose of this section is to familiarize the licensee with the expectations of Advance Care Planning, Inc. in the areas of financial reporting, notary requirements and basic business practices.

Upon completion of the class, the licensee will be able to set up basic business functions following a checklist and verbalize the expectations of Advance Care Planning, Inc.

Section Content: This section outlines the corporate expectations in the areas of wearing company identification and dress code. Basic business setup and practices such as business planning, budgeting, inventory and office requirements are covered. Notary requirements are discussed. A checklist is provided for an operating budget, inventory, hardware and software requirements, office equipment and supplies and a countdown to opening.

### The Advance Care Plan

Section Objective:

The purpose of this section is to familiarize the licensee with each component of a traditional and advance care plan and the software to create the client advance care plan.

Upon completion of the section, the licensee will be able to create a client advance care plan using the Advance Care Planning, Inc. software.

Section Content: This section presents each component of a care plan and explains the differences between a traditional care plan and an advance care plan in these areas. The license gets hands-on guidance with the Advance Care Planning, Inc. software using their information to create a care plan. Each section of the advance care plan is explained in detail with explanations of the purpose of the questions and the effect the answer will have on the client when the plan is implemented. The care planning cycles of a traditional care plan and advance care plan are discussed. The criteria for a good care plan according to the National Citizen's Coalition of Nursing Home Reform (NCCHNR) are presented. “A Day in the Life in a Nursing Home” is presented to illustrate the impact of an Advance Care Plan.

### Client Interview Skills

Section Objective:

The purpose of this section is to familiarize the licensee with basic communication and interviewing skills.

Upon completion of the section, the licensee will be able to conduct an interview for the client advance care plan.

Section Content: This section presents communication practices, explanations of the differences between three generations, the greatest generation, the silent generation and the baby boomers and how to communicate with each generation. The importance of the making a first impression is presented. Interview techniques are discussed. Role plays are conducted to give the licensee practice in talking to a variety of people in a variety of situations. The ACP process, and the cover letter and advance questionnaire are discussed.

### Marketing for Licensees

Section Objective:

The purpose of this section is to familiarize the licensee with basic marketing concepts.

Upon completion of the section, the licensee will be able to verbalize various methods for marketing the Advance Care Plan.

Section Content: This section presents the pricing guidelines for the Advance Care Plan. Methods to conduct a seminar and the seminars available are discussed. Suggestions on where to find clients is presented. Checklist are provided and reviewed for tracking advertising and referrals for maximum exposure of the Advance Care Plan. Detailed marketing guidelines are presented.

### Selling for Licensees

Section Objective:

The purpose of this section is to familiarize the licensee with basic selling concepts.

Upon completion of the section, the licensee will be able to verbalize various means of selling to engage their clients.

Section Content: This section presents the concept of emotional vs. logical selling. Various aging statistics are presented that illustrate the importance of planning for care. “A Day in the Life in a Nursing Home” is reviewed to reinforce the value of planning for care. Objections and how to overcome them are discussed. Sales tips and techniques are discussed. Licensees practice their 30 second elevator speech.

### Wrap-Up

Section Objective:

The purpose of this section is to familiarize the licensee with HIPPA regulations and client interaction.

Upon completion of the section, the licensee will be able to verbalize HIPPA regulations and verbalize various methods for client interaction.

Section Content: This section presents HIPPA requirements as they pertain to the Advance Care Plan and client interaction. Licensee computer skills for selling the Advance Care Plan and client computer skills for accessing their care plan are discussed. Client interaction in reducing and resolving client complaints is presented. Ruth's story is reviewed to reinforce the impact an Advance Care Plan can have on a person's life.

In operation, the present invention is adaptable to a method of training an interviewer to collect data for use in an advance care plan. The present invention is adaptable for providing a questionnaire directed to lifestyle preferences, and teaching the interviewer how to administer the questionnaire to a person in advance of need for care. Any suitable questionnaire or worksheet may be employed or adapted as desired to prepare the advance care plan.

The interviewer may any suitable person, including but not limited to a nurse, a social worker, an administrator, a person trained appropriately to interview, a physician, a pharmacist, a trained professional or the like. The data may be collected, and advance care plan prepared in advance of need for long-term care. For example, a questionnaire may be adapted to elicit the person's sleeping preferences or any other suitable preference, including any of those disclosed herein. For example, a questionnaire may be administered over the internet or a suitable network.

The present invention is adaptable to a method of gathering data for use in an advance care plan in any suitable manner. For example a questionnaire directed to lifestyle preferences may be provided. Likewise, the questionnaire may be administered to a client, a prospective resident of a facility, home care or a prospective resident of a long term care facility. It will be noted that the advance care pan may include a display of the lifestyle preferences of a person wherein the lifestyle preferences of the person are gathered in advance of need for care.

The principle and mode of operation of this invention have been described in its preferred embodiments. However, it should be noted that this invention may be practiced otherwise than as specifically illustrated and describe without departing from its scope.

1. A method of training an interviewer to collect data for use in an advance care plan comprising:
providing a questionnaire directed to lifestyle preferences, and
teaching the interviewer how to administer the questionnaire to a person in advance of need for care.

2. The method of claim 1 wherein the care is long-term care.

3. The method of claim 1 wherein the interviewer is a nurse.

4. The method of claim 1 wherein the interviewer is a social worker.

5. The method of claim 1 wherein the questionnaire elicits the person's sleeping preferences.

6. The method of claim 1 further comprising administering the questionnaire over the internet.

7. A method of gathering data for use in an advance care plan comprising providing a questionnaire directed to lifestyle preferences.

8. The method of claim 7 further comprising administering the questionnaire to a client.

9. The method of claim 7 further comprising administering the questionnaire to a prospective resident of a health care facility.

10. The method of claim 7 further comprising administering the questionnaire to a prospective resident of a long term care facility.

11. The method of claim 7 wherein the questionnaire elicits the person's sleeping preferences.

12. The method of claim 7 wherein the data is gathered in advance of need for care.

13. An advance care plan comprising a display of the lifestyle preferences of a person wherein the lifestyle preferences of the person are gathered in advance of need for care.

14. The advance care plan of claim 13 wherein the lifestyle preferences includes the person's sleeping preferences.

15. The advance care plan of claim 13 wherein the advance care plan is displayed over a network.

16. The advance care plan of claim 13 wherein the lifestyle preferences are gathered with a questionnaire.

17. The advance care plan of claim 13 wherein the lifestyle preferences are gathered by a trained person.

18. The advance care plan of claim 13 wherein the lifestyle preferences are gathered before the person receives services at a long-term care facility.

19. The advance care plan of claim 13 wherein the lifestyle preferences includes information about the person's pet.

20. The advance care plan of claim 13 wherein the lifestyle preferences are gathered by a nurse.
